(19) United States
(12) Patent Application Publication
(10) Pub. No.: US 2025/0147141 A1
(43) Pub. Date: May 8, 2025

(54) Code and Doppler based Multipath Mitigation

(71) Applicant: NextNav France, Puteaux (FR)

(72) Inventors: Rabih CHRABIEH, Montrouge (FR); Vinh Hoang Son LE, Massy (FR)

(73) Assignee: NextNav France, Puteaux (FR)

(21) Appl. No.: 18/753,895

(22) Filed: Jun. 25, 2024

Related U.S. Application Data
(60) Provisional application No. 63/595,954, filed on Nov. 3, 2023.

(51) Int. Cl. G01S 5/02

(52) U.S. Cl. CPC G01S 5/0218

(57) ABSTRACT

A multipath signal is received comprising a PRN code used to determine time of arrival of a signal of interest. A correlated received signal is generated by filtering and correlating of the received multipath signal. Short-term accumulation segments are generated based on the correlated received signal. Doppler hypotheses are applied to each of the short-term accumulation segments to generate phase-corrected short-term accumulated blocks. The phase-corrected short-term accumulated blocks are accumulated to generate long-term accumulated blocks for each Doppler hypothesis. Alternatively, cross-correlation samples are generated for signal samples for each short-term accumulation segment, and the cross-correlation samples are accumulated to generate a long-term accumulated block.

### RELATED APPLICATIONS

This application claims priority to U.S. Provisional Patent Application No. 63/595,954, filed Nov. 3, 2023, all of which is incorporated herein by reference in its entirety.

### BACKGROUND

The performance of a Global Navigation Satellite System (GNSS) and cellular positioning systems using Time Difference of Arrival (TDOA) can be strongly impacted by multipath and Non-Line-of-Sight (NLOS) signal issues. Multipath signal propagation may occur, for example, in a situation in which a signal can take multiple paths (e.g., due to reflections, diffractions, etc.), thereby resulting in multiple copies of the signal (typically at different amplitudes and offsets) being received at the receiver. A Non-Line-of-Sight path is generally any type of delayed path for the signal, rather than a direct Line-of-Sight (LOS) path between transmitter and receiver, wherein the delay can distort distance calculations that use the signal. Various techniques have been developed to compensate for multipath and NLOS signal issues with varying degrees of complexity, cost, and effectiveness.

### SUMMARY

In some embodiments, a system or method (performed by a computing system) includes receiving a multipath signal comprising a code, the code being a Pseudo-Random-Noise (PRN) code of a system in which the code is used to determine a time of arrival of a signal of interest within the multipath signal; generating a correlated received signal by performing filtering and correlating of the received multipath signal with a local replica of the code; generating a plurality of short-term accumulation segments based on the correlated received signal; applying a plurality of Doppler hypotheses to each of the short-term accumulation segments to generate sets of phase-corrected short-term accumulated blocks; and accumulating the phase-corrected short-term accumulated blocks to generate long-term accumulated blocks for each Doppler hypothesis.

In some embodiments, a system or method (performed by a computing system) includes receiving signal data that includes a plurality of signal samples that includes a signal of interest and that are accumulated non-coherently; generating a correlated received signal by performing filtering and correlating of the received multipath signal with a local replica of the code; generating a plurality of short-term accumulation segments using the signal samples; accumulating blocks of signal samples in each of the short-term accumulation segments to generate a plurality of short-term accumulated blocks; for each short-term accumulation segment, determining a cross-correlation for each of the signal samples therein to generate cross-correlated samples; and accumulating the cross-correlated samples to generate a long-term accumulated block.

### BRIEF DESCRIPTION OF THE DRAWINGS

FIG. 1 is a simplified illustration of an example operational environment within a region having one or more computing devices and a network of cell towers/base stations among other features, in accordance with some embodiments.

FIG. 2 is a simplified schematic diagram showing a function of a local replica and near-causal filter, in accordance with some embodiments.

FIG. 3 is a simplified schematic diagram showing an example overview of a process for long-term accumulation of received cellular signals that compensates for Doppler effects as wells as using a TOA-MF filter for a coherent case, in accordance with some embodiments.

FIG. 4 illustrates an effect of carrier phase correction per Doppler hypothesis and windowing operations performed on short-term accumulation blocks, as shown in FIG. 3, in accordance with some embodiments.

FIG. 5 is a simplified schematic diagram showing an example overview of a process for applying a set of Doppler values or hypotheses in parallel using multiple FFTs, in accordance with some embodiments.

FIG. 6 presents graphs of impulse responses that show how Doppler hypotheses or filtering can reduce interference from multipath that have sufficiently different Doppler, in accordance with some embodiments.

FIG. 7 presents graphs of impulse responses that show how TOA-MF filtering further reduces the interference from remaining multipath, in accordance with some embodiments.

FIG. 8 shows graphs of an impulse response in the complex plane with and without filtering by TOA-MF, in accordance with some embodiments.

FIG. 9 shows enlarged portions of the graphs in FIG. 8, in accordance with some embodiments.

FIG. 10 shows several impulse responses that illustrate how well Doppler filtering works after an accumulation of signal data, in accordance with some embodiments.

FIG. 11 shows the strongest path of the peak power for several Doppler hypotheses, in accordance with some embodiments.

FIG. 12 shows graphs of power vs. time of arrival for another example taken from the same data accumulations as for the example of FIGS. 6-11, in accordance with some embodiments.

FIG. 13 is a simplified schematic diagram showing an example overview of a process 1300 for a non-coherent approximate ML solution, in accordance with some embodiments.

FIG. 14 illustrates the components of a transmitter, a receiver, and a server, in accordance with some embodiments.

### DETAILED DESCRIPTION

The present invention provides improved techniques for compensating for or removing multipath and Non-Line-of-Sight (NLOS) signal issues by combining Doppler-based methods with near-causal filters and Time of Arrival (TOA) Matched Filters (TOA-MF) to facilitate or improve estimation of the TOA of the signal that can be used to determine the position of a computing device or system. Example near-causal filters and TOA Matched Filters that can compensate for multipath signal propagation are shown in U.S. Pat. Nos. 10,042,037 and 10,880,678, which are assigned in common with the present invention and incorporated by reference as if fully set forth herein. The techniques shown in these previous patents provide a low-cost solution with relatively good performance using code-based multipath mitigation, wherein the time domain is pre-filtered in order to separate the earliest path from other or subsequent paths. In some embodiments, therefore, the present invention augments the solutions in these patents with a Doppler-based method, which is generally useful when a computing device (e.g., cell phone, smart phone, tablet computer, notebook/laptop computer, gaming device, vehicle-based computer, smart watch, etc.) to be located is moving (such that the multipath have several diverse or different Dopplers), as when being carried by a moving user/person or in a moving automobile, among other situations. The combination of the solutions in these patents and the Doppler-based solutions herein can provide several tens of dB in multipath reduction, thereby better enabling a determination of the earliest path. A code, or code-sequence, as disclosed herein may be, for example, a Pseudo-Random-Noise (PRN) code sequence, a code-division multiple access (CDMA) code sequence, a Global Navigation Satellite System (GNSS) code sequence, a GPS L1 code sequence, or other transmitted code that may be used in a system to determine a time of arrival of the transmitted signal for a receiver.

The TOA of the signal can be used with other signals to determine the location of the computing device. Many applications that run on a computing device require an accurate determination of the location of the computing device in order to function properly, so a more accurate TOA is necessary for a more accurate location determination. Some of the more important applications that may use location determinations are used with emergency 911 services in the United States and similar emergency services in other countries, because it is imperative that emergency responders be able to find a person in need of emergency services as quickly as possible. Such emergency services typically provide the emergency responders with an estimated location of the person who placed the emergency call based on the determined location of the computing device. However, if the location-detection capabilities of the person's computing device do not produce accurate results, e.g., due to an inaccurate TOA calculation, then valuable time can be wasted by the emergency responders trying to find the person who placed the emergency call. Additionally, an accurate location determination can be used to calibrate one or more sensors of the computing device, so that data from the sensors can be used for location determination, altitude determination, compass direction determination, and other purposes.

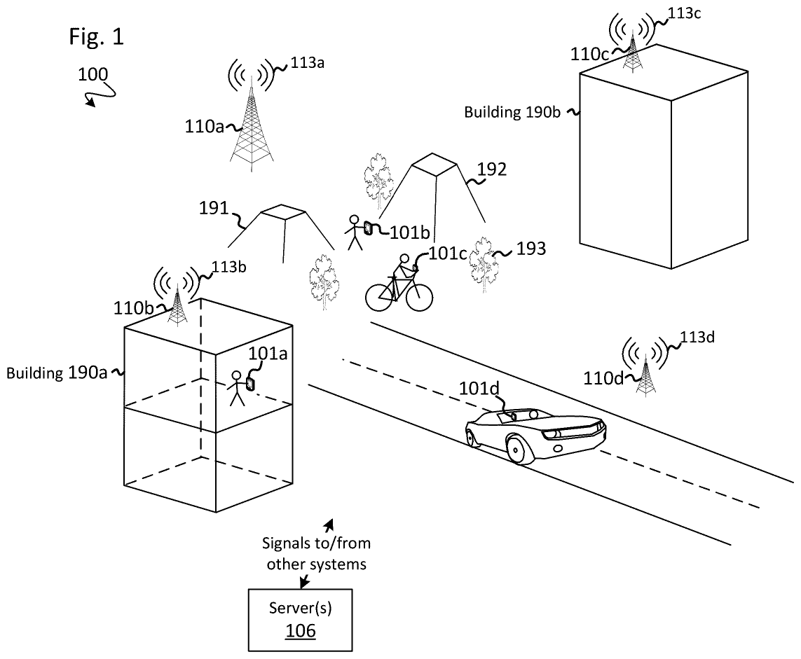

FIG. 1 is a simplified illustration of an example operational environment within a region having one or more computing devices and a network of cell towers/base stations among other features, in accordance with some embodiments. The operational environment or region 100, for example, contains a network of cell towers/base stations 110a-d (sometimes referred to herein as just “cell towers” or “base stations” and collectively or individually denoted herein as 110), example computing devices 101a-d (sometimes collectively or individually denoted herein as 101), any number of buildings 190a-b, any number of geographical features or obstacles (e.g., hills 191, mountains 192, trees 193, tunnels (not shown), bridges (not shown), etc.), and any number of servers 106 (e.g., one or more additional computing devices sometimes collectively referred to herein as server 106). FIG. 1 also shows general cellular signals 113a-d that are associated with the respective base stations 110a-d, in accordance with some embodiments.

The cell towers/base stations 110a-d may be located at different altitudes and horizontal positions within the operational environment 100. The base stations 110a-d may transmit the signals 113a-d using one or more common multiplexing parameters—e.g., time slot, pseudorandom sequence, or frequency offset. The servers 106 and the computing devices 101 may exchange information with each other. The base stations 110a-d may include synchronized beacons of a wide area positioning system and may form a CDMA, TDMA, or OFDMA network.

A cell tower is a physical structure that houses antennas and other equipment used to provide wireless coverage to a geographic area. It is usually owned by a tower company and leased to wireless carriers who place their equipment on the tower. By comparison, a base station includes the equipment used to transmit and receive wireless signals between a computing device and the network. It includes radio equipment, such as transceivers and antennas, as well as baseband processing equipment that converts digital signals into analog signals and vice versa. However, for brevity, cell towers and base stations are both referred to herein as “base stations” with the understanding that a base station may also refer to a cell tower.

The computing devices 101a-d are associated with (e.g., being carried by or along with) a person or user. Additionally, since this disclosure involves Doppler effects of wireless signals, the users (and, thus, the computing devices 101a-d) are typically in motion. For example, the first computing device 101a is associated and moving with a user who is moving on foot (e.g., walking, running, etc.) inside the building 190a; the second computing device 101b is associated and moving with a user who is moving on foot (e.g., walking, running, etc.) outdoors; the third computing device 101c is associated and moving with a user who is moving on a bicycle; and the fourth computing device 101c is associated and moving with a user who is moving in a vehicle. Additionally, the buildings 190a-b and the various geographical features or obstacles (e.g., the hills 191, mountains 192, trees 193, tunnels (not shown), bridges (not shown), etc.) generally cause multipath effects of the wireless signals, since the users and the computing devices 101 are generally moving in, through or around these objects.

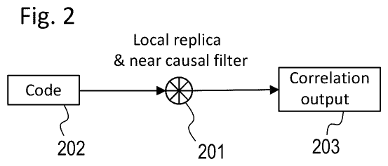

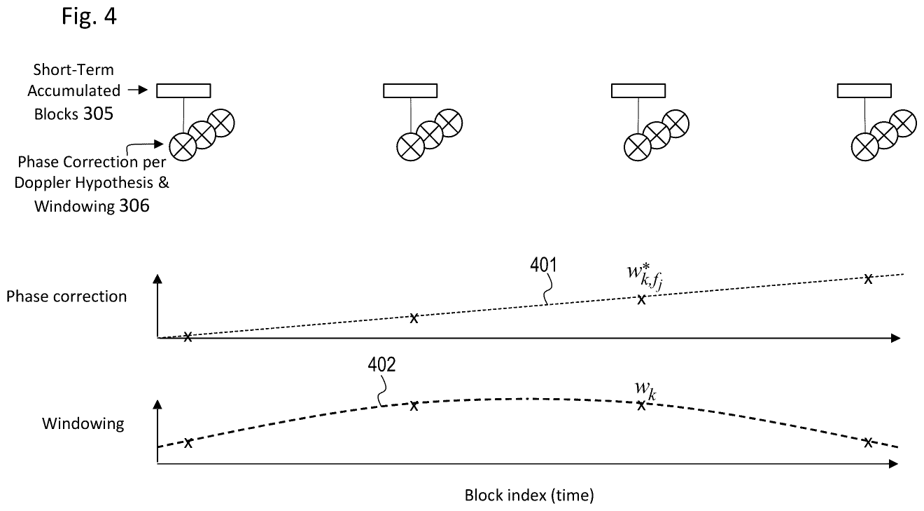

FIG. 2 is a simplified schematic diagram showing a function of a local replica and near-causal filter, i.e., a TOA-MF filter 201, in accordance with some embodiments. The TOA-MF filtering is usually performed together with correlation with the local replica. The TOA-MF filter 201 (e.g., typically implemented in the computing device 101, but possibly alternatively implemented in the server 106) receives code 202 (e.g., a Pseudo-Random-Noise (PRN) code or PRN sequence associated with a CDMA or GNSS system) of a received signal and uses time domain or frequency domain near-causal filtering in order to reshape a reference transmitted waveform of the code 202 and transform the correlation output 203 into near-causal shape. In some embodiments, the TOA-MF filter 201, for example, is applied at a relatively high sampling rate for Code-Division Multiple Access (CDMA) codes (e.g., having a duration of about 1 ms for some GNSS systems). Likewise, for Orthogonal Frequency-Division Multiplexing (OFDM) systems (e.g., for 4G/5G cellular systems), the near-causal filtering applies to an OFDM symbol. In some embodiments, the near-causal filtering may alternatively be applied at a later stage, e.g., on the short-term accumulation blocks (as shown in FIG. 4, described below) or on the long-term accumulation blocks. However, in some embodiments, for this technique to work properly with the TOA-MF filter 201, a significant, or relatively large, number of correlators are preferably computed for the TOA-MF filter 201, because near-causal filters need a large number of samples or correlators to be able to reshape the correlation output 203, so that interference from later arriving signals onto early arriving signals can be reduced, wherein the arriving signals mentioned herein are all time-shifted copies or echoes of a single original transmitted signal.

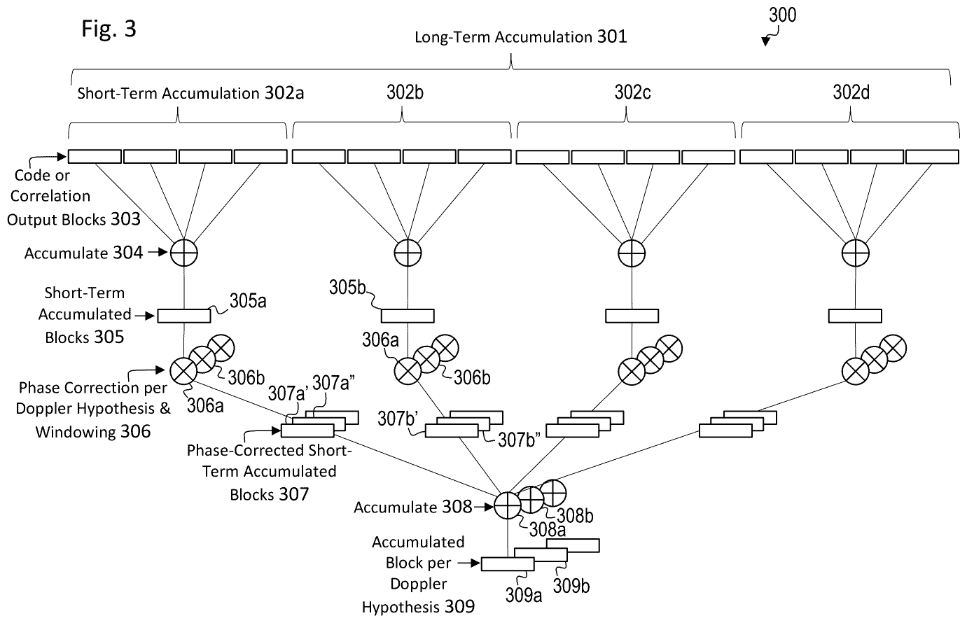

FIG. 3 is a simplified schematic diagram showing an example overview of a process 300 for long-term accumulation 301 of received cellular signals that compensates for Doppler effects as wells as using a TOA-MF filter for a coherent case (i.e., the carrier phase is known or can be tracked), in accordance with some embodiments. The code based TOA-MF filter is applied to eliminate or reduce interference from some of the late arriving signals (multipath) and then the Doppler hypotheses are applied to get a clearer picture of, i.e., to isolate, the signal of interest within the multipath signals. This technique, thus, provides a solution in two dimensions—Doppler compensation and code phase TOA-MF filtering.

In general, the long-term accumulation 301 is divided into multiple short-term accumulations 302 (or segments), i.e., the long-term accumulation 301 in the time domain is accomplished by implementing a series of short-term accumulation segments 302a-d of individual code blocks or correlation output blocks 303. Thus, segments of the code blocks or correlation output blocks 303 (e.g., 10 ms cellular signal frames) are accumulated (at 304) to generate multiple respective short-term accumulated blocks 305 (i.e., each is a block of several samples). When there is multipath, each short-term accumulated block 305 (or short-term accumulation segment) can be, for example, 20 or 50 or even 100 samples or correlators.

In general, for short segments of the code blocks or correlation output blocks 303, a substantial portion of the multipath can be removed relatively well by performing code based interference or multipath cancellation, e.g., TOA-MF filtering. On the other hand, longer segments of the code blocks or correlation output blocks 303 can be used also to correlate for a given Doppler hypothesis with which to automatically eliminate or remove additional portions of the multipath. The earliest remaining “echo” or “signal copy” after Doppler based filtering is likely to indicate the earliest time of arrival of the signal of interest.

Therefore, carrier phase correction and accumulation windowing (i.e., weighting) is performed (at 306) for multiple Doppler hypotheses or corrections (repeated for each Doppler hypothesis) for each of the short-term accumulated blocks 305 to generate respective sets of carrier phase-corrected short-term accumulated blocks 307. In some embodiments, the TOA-MF filter 201, equivalent to windowing in the frequency domain (i.e., filtering in the time domain or frequency domain) of the code phase, is typically applied in 303 to reduce the sidelobes of the sync waveform of the received signal (in the code phase domain). Reducing the sidelobes helps to isolate the multipath by removing some of the overlap of the sidelobes. The carrier phase-corrected short-term accumulated blocks 307 (for each having the same applied Doppler hypothesis) are then further accumulated (at 308) to generate long-term accumulated blocks 309 (i.e., for the long-term accumulation 301) for each Doppler hypothesis.

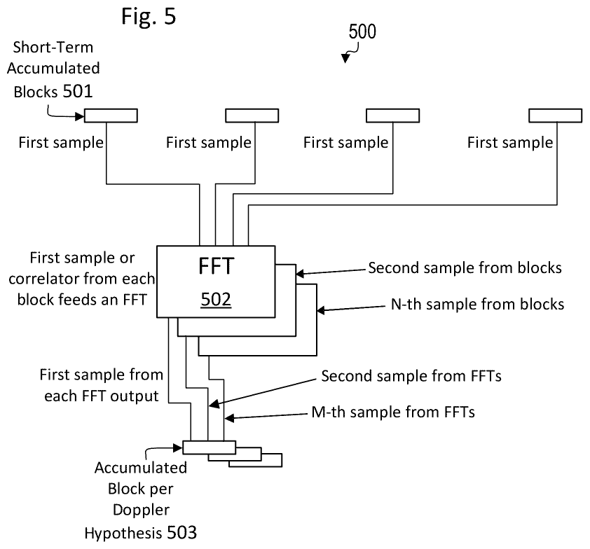

In other words, a set of Doppler hypotheses (or corrections) is applied (at 306) to each of the short-term accumulation segments, i.e., the output of the code-based correlation and the TOA-MF filter 201, before a coherent long-term accumulation of the codes is performed (at 308). In carrier phase correction, multipaths that have Doppler values that are significantly distinct from a current Doppler hypothesis are automatically reduced by applying (at 306) the current Doppler hypothesis. Additionally, each Doppler hypothesis can be applied separately as a carrier phase ramp or discrete Fourier transform (DFT). Alternatively, a set of Doppler values or hypotheses can be applied in parallel using respective Fast Fourier Transforms (FFTs), e.g., one FFT per time sample in the code as shown in FIG. 5, as described below. In some embodiments, respective FFTs can be oversampled to produce finer Doppler hypotheses by extending the time domain block length with zero padding. Generally, however, there are few Doppler hypotheses and the FFT is not necessarily efficient.

Returning attention to FIG. 3, as one simplified example, a first Doppler hypothesis is applied (at 306a) to short-term accumulated blocks 305a and 305b to generate carrier phase-corrected short-term accumulated blocks 307a′ and 307b′, respectively; and a second Doppler hypothesis is similarly applied (at 306b) to the short-term accumulated blocks 305a and 305b to generate carrier phase-corrected short-term accumulated blocks 307a″ and 307b″, respectively. The carrier phase-corrected short-term accumulated blocks 307a′ and 307b′, having the applied first Doppler hypothesis at 306a, are accumulated at 308a to form long-term accumulation block 309a. Similarly, the carrier phase-corrected short-term accumulated blocks 307a″ and 307b″, having the applied second Doppler hypothesis at 306b, are accumulated at 308b to form long-term accumulation block 309b.

To elaborate, several contiguous code blocks or correlation output blocks 303 are accumulated in the time domain at 304 to reduce the amount of subsequent processing by the server 106 and/or computing device 101.

The input to each of the accumulation stages 304 is shown as respective blocks (e.g., about a full 1 ms code in the example of GNSS, or several milliseconds that are accumulated into about 1 ms) of the code blocks or correlation output blocks 303.

Multipath may be further reduced via Doppler hypotheses and long-term accumulation by pre-applying windowing, e.g., Dolph-Chebyshev windowing, onto the long-term set of PRN codes, e.g., the code blocks or correlation output blocks 303 for the long-term accumulation 301. The windowing is performed such that the codes at the edges (i.e., near the beginning or end of the long-term accumulation 301) are weighted differently from center codes. Windowing significantly reduces the impact of multipath whose Doppler is relatively far from a current Doppler hypothesis (but it does not sufficiently weaken multipath with very near Doppler, hence, there is a tradeoff that depends on the scenario).

The near-causal filter of the TOA-MF filter 201 serves as a type of windowing in the frequency domain but applied at the code level, not at the long-term accumulation level. It is a complex type of windowing with a non-linear phase in the frequency domain.

FIG. 4 illustrates an effect of the carrier phase correction per Doppler hypothesis and windowing operations at 306 performed on the short-term accumulation blocks 305, as shown in FIG. 3, in accordance with some embodiments. Carrier phase correction (shown by graph 401) is denoted as w*_{k,f}_{ⱼ}. Windowing (shown by graph 402) is denoted as Wₖ, showing that the codes at the edges (i.e., the far left and the far right points in the graph 402) are weighted differently from center codes. (Each vertically aligned point in the graphs 401 and 402 correspond to one of the short-term accumulation blocks 305 and the corresponding carrier phase correction per Doppler hypothesis and windowing operations at 306.) Applying such Doppler weights, however, is optional and does not always help. This depends on the amount of interference from various directions.

Each path (or tap) of interest is denoted as j and has its own Doppler value. Correlations (or channel estimate) of interest shown in FIG. 4 are denoted by ĥ_{n,f} in the formula of Equation 1:

$${\hat{h}}_{n , f} = {\sum }_{k} {w}_{k , f}^{*} {x}_{n}^{H} {y}_{k} = {x}_{n}^{H} {\sum }_{k} {w}_{k , f}^{*} {y}_{k} . \qquad ( Equation 1 )$$

The samples or correlators that are computed are denoted by index n. The reference sequence or local replica is denoted xₙ and is delayed by an amount corresponding to index n. Thus, ĥ_{n,f} is the output channel or correlation estimate for this delay and for a given Doppler correction f. A full block or vector of samples (i.e., of the code blocks or correlation output blocks 303) is denoted yₖ, such as for 1 ms or an accumulation (i.e., the short-term accumulation blocks 305) of several milliseconds into 1 ms. Additionally, the carrier phase correction w*_{k,f} (graph 401) is one scalar complex rotation per short-term accumulation block 305, and the windowing (graph 402) Wₖ is one real window scaling per block.

The process 300 (e.g., at step 306, as illustrated by graph 401) may precompute y_{f}=Σₖw*_{k,f}yₖ for a set of Doppler corrections f that covers a range of Dopplers fᵢ that may be expected for the diverse multipath, e.g., with sufficiently good resolution to reduce the impact of inaccurate Doppler estimation. The output ĥ_{n,f} may be computed for a few correlators in the vicinity of where the earliest arrival is expected to occur or over an extended region if an Inverse Fast Fourier Transform (IFFT) is used, for example, in 4G or 5G cellular systems.

The code phase filtering at 303 applies at the level of (or is embedded in) xₙ^{H}yₖ. The windowing over Doppler, shown by the graph 402 in FIG. 4, may be inserted as shown in Equation 2:

$${\hat{h}}_{n , f} = {x}_{n}^{H} {\sum }_{k} {w}_{k , f}^{*} {W}_{k} {y}_{k} . \qquad ( Equation 2 )$$

Thus, the 2D output ĥ_{n,f} contains correlations over time delay and Doppler.

In accordance with the process 300, therefore, the interference from multipath has been reduced in two ways:
1) In code phase via the TOA-MF filter applied to the reference sequence or local replica x or to the block or vector of samples y (i.e., the code blocks or correlation output blocks 303), at any stage, but requiring a large number of samples (so usually it's applied earlier in the chain, e.g., at 303, before the number of samples is reduced to a few correlators, or at the end at 309, after all accumulations if IFFTs are used to compute all the samples ĥ_{n,f}); and
2) in Doppler via the summation with coefficients w*_{k,f}Wₖ.

After TOA-MF (e.g., at 303) and Doppler filtering (e.g., at 306), the process 300 locates or determines the signal of interest as the earliest path or signal from among the multipath signals or the strongest path or signal among multiple earliest signals from among the multipath signals. This uses a 2D grid of time domain samples and Doppler samples, where each point in the grid is a coherent integration (with specific time delay and Doppler hypothesis). The process 300 selects the earliest arrival from this grid (or optionally detects all available paths, depending on the problem). This is done by searching the time domain, sample by sample, in increasing order of time. For all Doppler hypotheses, as long as the samples are at the noise or at the early side lobe level, the process moves to the next sample in time.

As an alternative example, Doppler hypotheses for a given time sample can be obtained via an FFT over the short-term accumulation blocks for the fixed time sample, as shown in FIG. 5. FIG. 5, thus, is a simplified schematic diagram showing an example overview of a process 500 for applying a set of Doppler values or hypotheses in parallel using multiple FFTs 502 (e.g., as at the code phase filtering at 306 in FIG. 3), e.g., one FFT per corresponding time sample in the code of short-term accumulation blocks 501 (e.g., similar to 305 in FIG. 3), in accordance with some embodiments. The first time sample from each block 501, thus, is provided to and processed by a corresponding first FFT 502. In some embodiments, each FFT 502 is relatively short, so higher resolution Doppler is obtained by extending to more blocks 501 (e.g., from the 4 blocks 501 shown to 8, 16 or more) or by adding additional blocks that have zero values, i.e., zero padding the FFT. Additionally, the second or subsequent time sample from each block is provided to and processed by a corresponding second or subsequent FFT 502. The outputs of the first FFT 502 for each first time sample are accumulated to generate first long-term accumulated blocks 503 (e.g., similar to 309a in FIG. 3). The outputs of the second (and each subsequent) FFT 502 for each second (and each subsequent) time sample are accumulated to generate first long-term accumulated blocks 503 (e.g., similar to 309b in FIG. 3).

When the process 500 reaches a block for a time sample that shows a substantial energy rise (e.g., above noise and side lobe level, e.g., more than 12 dB above), for one of the Doppler hypotheses, then this is an indication of the earliest path with the given Doppler hypothesis. If multiple Dopplers show an energy rise, a few cases are considered:
1. If the Doppler hypotheses are sufficiently far (e.g., the Doppler hypotheses can be far at least by roughly one over the accumulation duration in Hz—although this may be insufficient as rule and it depends on the windowing type—nevertheless, when looking for a first detection of energy rise, this could be enough as the 13 dB weaker signal will generally not cross a threshold that is sufficiently above noise and side lobe level), then TOA is estimated for each Doppler hypothesis that shows an energy rise above threshold, and the earliest of these is chosen. In some embodiments, TOA estimation is performed as described in U.S. Pat. Nos. 10,042,037 and 10,880,678 (e.g., by fitting to an early part of the curve in the operating region, and possibly by considering noise whitening; the fitting may consider more than one path).
2. Same as for (1) above, but a high quality (or strong signal) path is preferably selected rather than a weak one, depending on the needs of the subsequent multilateration algorithm. Indeed, a weak signal path may be given a low weight and considered suspicious while a strong signal path among multiple early paths can be given more importance and considered more reliable.
3. The Doppler hypotheses are nearer than is proposed in (1) above. In this example, the Doppler hypotheses might correspond to the same path but observed from two nearby Doppler hypotheses. In this situation, it can be preferred to select the stronger path rather than the earlier path.

The TOA estimation usually requires computing the correlation for a second time sample (or for several time samples), adjacent to the one where the substantial energy rise was observed. The set of one or more adjacent time samples is used to fit to the reference sequences (e.g., with different time delays, as explained in U.S. Pat. Nos. 10,042,037 and 10,880,678). In some embodiments, an initial operating region of interest can be found or determined by using non-coherent integration to roughly locate where the energy starts. Once the energy start is determined, the TOA estimation process may move backward (and/or forward) in time domain using coherent integration with Doppler hypotheses until a signal is no longer found (The TOA estimation process may have to move back quite a bit in case a signal is hidden under early side lobes in the non-coherent integration if it doesn't benefit from Doppler filtering). When the region of interest is determined, the TOA estimation process finds the first point above the energy rise, obtains a second adjacent point, and performs the TOA estimation as described above.

### Example

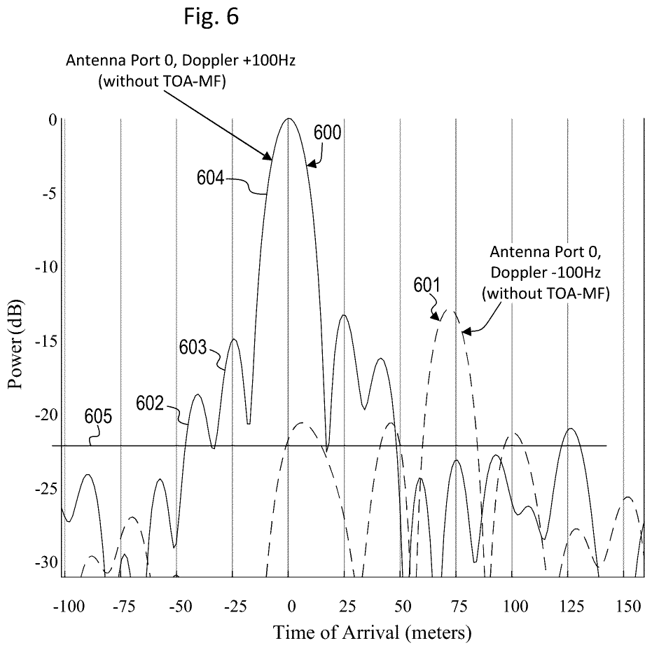

FIGS. 6-12 provide an example in which a data accumulation of 50 ms is performed in a field trial in downtown San Jose, California, (a non-dense environment) of long-term evolution (LTE) 20 MHz signals, in the 1900 band, and for one cell with two antenna ports (AP0 and AP1). (In the LTE standard, a cell can transmit a Cell Reference Signal (CRS) pilot signals from one or more antenna ports, each performing as a different beam or different polarization.) The data accumulation was obtained from a car moving at about 55 km/h.

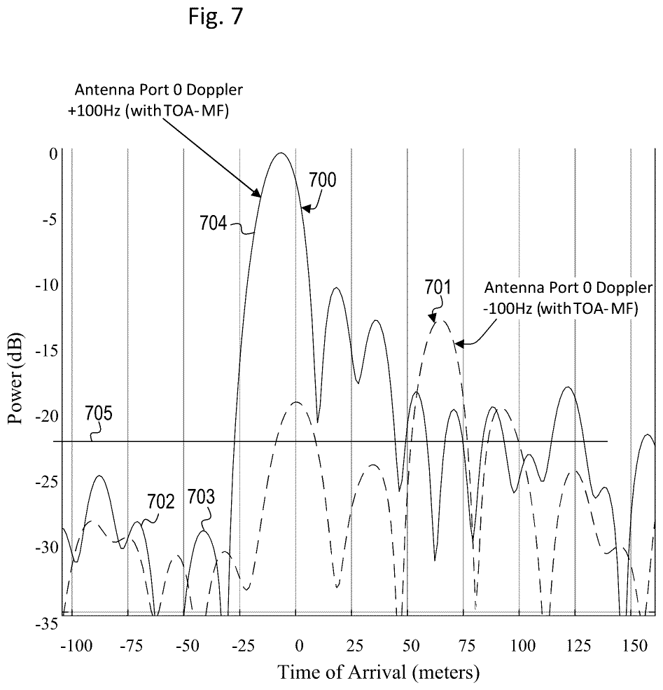

After accumulation over 50 ms for various Doppler hypotheses, the amplitude of the impulse response (without phase information) over time is shown in FIGS. 6 and 7 for one antenna port (AP0) and the two Doppler hypotheses of +100 Hz and −100 Hz, where the “0” point on the x-axis is arbitrarily shifted (or translated), and does not denote where TOA is located, as an example. In FIG. 6, the impulse responses are shown without filtering by TOA-MF. In FIG. 7, they are shown with filtering by TOA-MF. FIG. 6, thus, presents graphs 600 and 601 of impulse responses that show how Doppler hypotheses or filtering can reduce interference from multipath that have sufficiently different Doppler (relative to the accumulation period of 50 ms), in accordance with some embodiments. For the graph 600, for example, the sidelobes (e.g., 602 and 603) remain relatively strong compared to the main lobe 604. The sidelobes (e.g., 602 and 603) are not all sufficiently below a power threshold 605, such that the process might lock on to one of them as the earliest signal instead of the main lobe 604. FIG. 7 presents graphs 700 and 701 of impulse responses that show how TOA-MF filtering further reduces the interference from remaining multipath (having near Doppler relative to the accumulation period), in accordance with some embodiments. For the graph 700, for example, the sidelobes (e.g., 702 and 703) have been significantly reduced compared to the main lobe 704 and in comparison with graph 600. This double filtering process, thus, substantially removes multipath interference, so that the impulse responses after both filters look quite clean, as shown in FIG. 7. The reduced sidelobes (e.g., 702 and 703) are sufficiently below a power threshold 705 that the process will not lock on to them, but instead will lock on to the main lobe 704 as the appropriate earliest signal.

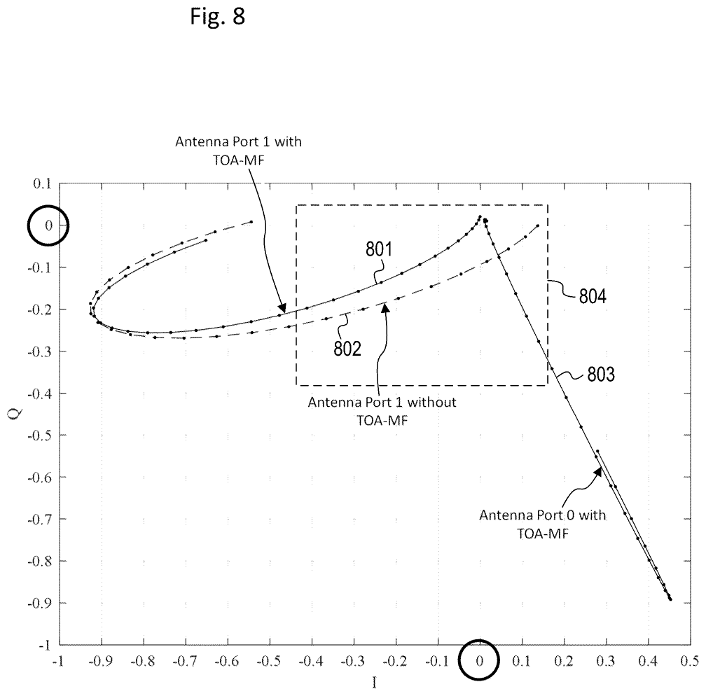

For this example, the result of this double filtering process is further illustrated in FIG. 8, which shows graphs of the impulse response in the complex plane with and without filtering by TOA-MF, in accordance with some embodiments. The graphs show the impulse responses for the +100 Hz Doppler hypothesis in the complex plane (I component vs. Q component) in the small region of interest around the main lobes for antenna port 1 (with and without TOA-MF filtering—graphs 801 and 802, respectively) and antenna port 0 (with TOA-MF filtering—graph 803).

The impulse responses for the +100 Hz Doppler hypothesis go from near zero (at 0,0) to the peak of the main lobes, and a little beyond the peak where the main lobes start to drop down. Graph 803 shows that the less an impulse is interfered with by noise or other multipath, the more it looks like the impulse response of Antenna Port 0, which shows a nearly straight (roundtrip) line that progresses back onto itself, with some phase (i.e., angle), as for a near line-of-sight signal. This result occurs because the reference impulse response that is relatively free of noise and interference has only a real component; thus, it appears like a line rotated by some constant phase in the complex plane. On the other hand, when the received impulse response rotates and draws some curve with rotating phase in the complex plane, as shown by graphs 801 and 802, then either there is residual noise or the response is the sum of two or more paths. In this example, the power levels of the signals are high compared to noise, so the interference more likely to be from multipath effects rather than noise. As a result, Antenna Port 0 (graph 803) shows a relatively clean response (i.e., a nearly straight line), but Antenna Port 1 (graphs 801 and 802) shows multipath interference (i.e., remaining multipath after Doppler filtering).

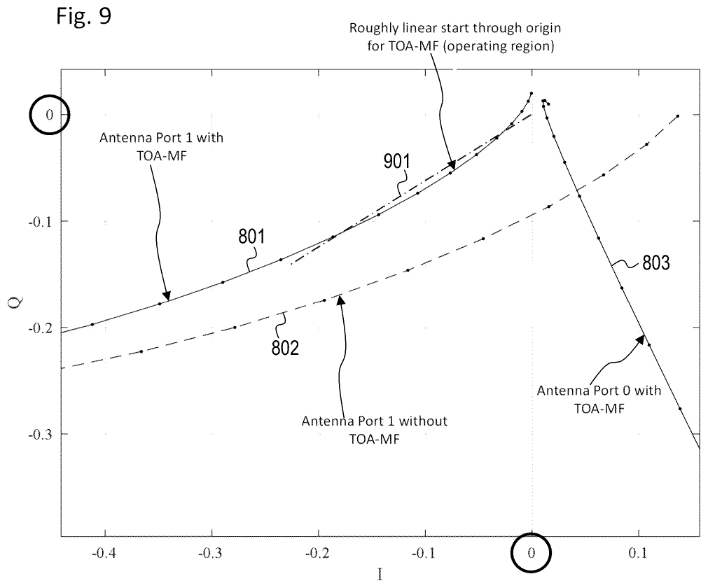

For this example, FIG. 9 shows enlarged portions of the graphs 801-803 in FIG. 8 (indicated by dashed box 804 in FIG. 8) of the impulse response in the complex plane with and without filtering by TOA-MF, in accordance with some embodiments. The enlarged portions of the graphs 801-803 show in more detail how the curves rise from zero (i.e., origin (0,0)) and grow toward the peak. For the case of TOA-MF filtering (graphs 801 and 803), the early regions of the curves (which start near the origin (0,0)) are relatively close to a straight line. Graph 803 for Antenna Port 0, in fact, is almost a straight line throughout, because it is a unique path or any multipath has been removed. For graph 801 for the multipath interfered AP1, this is shown by comparison with an overlaid straight line 901 that passes directly through the origin (0,0). In this operating region before the peak, but sufficiently above noise, the TOA-MF filtering manages to reduce significantly interference from late multipath. The graph 802 without TOA-MF filtering, by comparison, also does not start as near to the origin (0,0) as do the graphs 801 and 803 with TOA-MF filtering. Additionally, the AP1 graphs 801 and 802 noticeably curve due to interference from multipath. This generally means that a sum of two paths curves more significantly and may not go through the origin (0,0), because the interference adds up such that the graph can go anywhere in the space.

The combination of Doppler and TOA-MF filtering (applied in either order) has substantially reduced the multipath interference. Therefore, it is possible to more accurately estimate the TOA or the carrier phase (i.e., the phase of the impulse response) when working in the operating region (where Signal to Interference and Noise Ratio, SINR, is higher, i.e., before the peak or near the origin of the graphs).

In some situations, it can be possible to fit more than one path to the rising impulse response, which would thus indicate whether the lobe consists of two or more paths. (E.g., as shown in U.S. Pat. Nos. 10,042,037 and 10,880,678.) However, there may be a small difference in Doppler between the two or more paths to be considered.

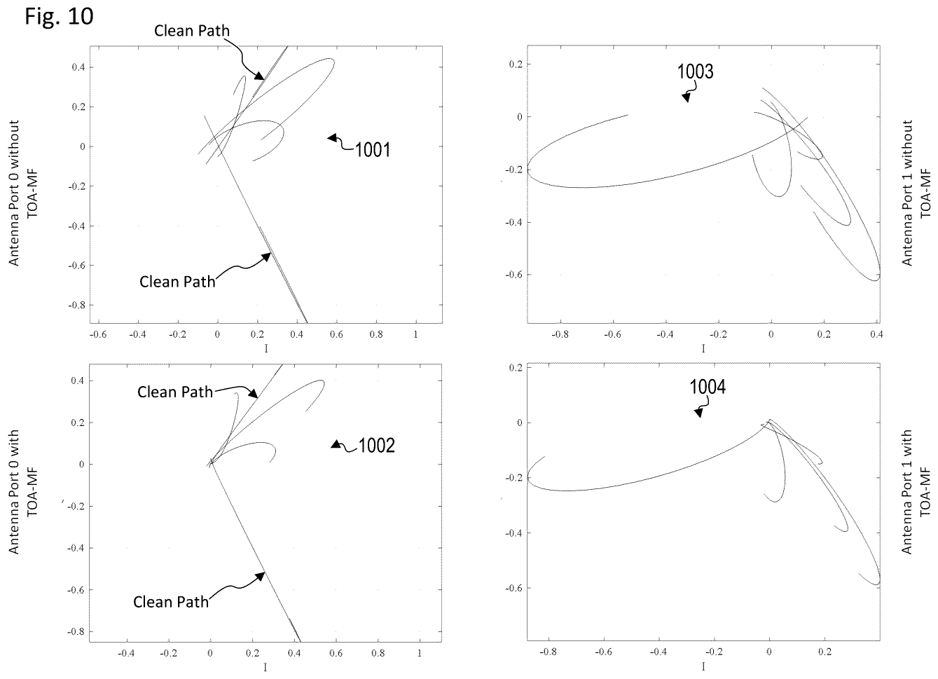

For this example, FIG. 10 shows several impulse responses that illustrate how well Doppler filtering works after about 50 ms of accumulation of signal data, in accordance with some embodiments. Impulse responses are shown, in this example, for five Doppler hypotheses (6 Hz, 32 Hz, 54 Hz, 80 Hz, and 100 Hz) where there are sufficiently strong signals, for each of AP0 and AP1, and for the cases without and with TOA-MF filtering. Graphs 1001 show the five impulse responses for AP0 without TOA-MF filtering; graphs 1002 show the five impulse responses for AP0 with TOA-MF filtering; graphs 1003 show the five impulse responses for AP1 without TOA-MF filtering; and graphs 1004 show the five impulse responses for AP1 with TOA-MF filtering.

Most of the impulse responses for AP0 and AP1 without TOA-MF filtering (graphs 1001 and 1003), except two for the AP0 graph 1001 (the straight “clean paths”), show significant curvature throughout the responses. This indicates that Doppler filtering alone is insufficient, since significant multipath remains after this type of filtering. On the other hand, for the impulse responses for AP0 and AP1 with TOA-MF filtering (graphs 1002 and 1004), the straight “clean paths” still occur, but even all of the other impulse responses show a definite tendency to start from the origin 0 and follow a relatively straight line for at least a brief period (i.e., the operating region of interest) before starting to curve.

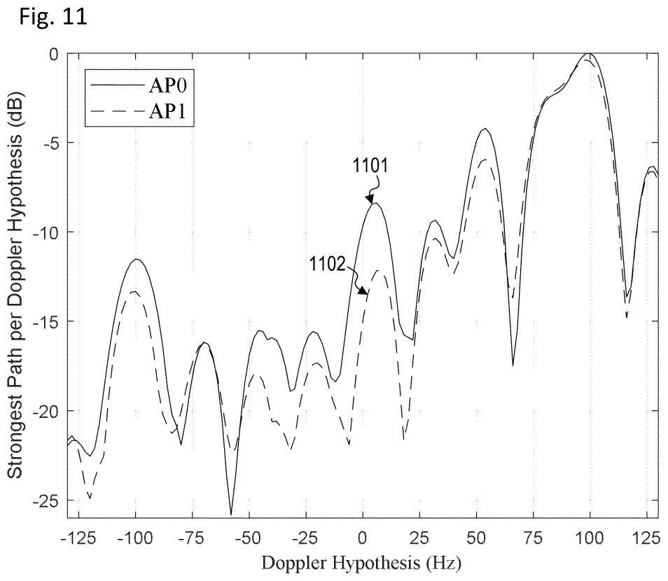

For this example, FIG. 11 shows the strongest path of the peak power for several Doppler hypotheses for AP0 (graph 1101) and AP1 (graph 1102), in accordance with some embodiments. Additionally, the paths at Doppler hypotheses 80 Hz and 100 Hz are clearly visible and can potentially be separated using 50 ms accumulation windows.

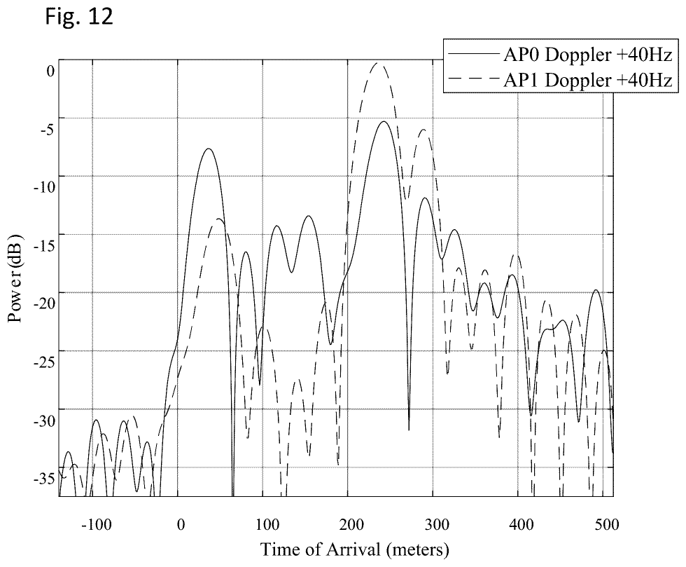

FIG. 12 shows graphs of power vs. time of arrival for another example taken from the same data accumulations as for the example of FIGS. 6-11, but for the 10 MHz bandwidth in the 700 MHz band, in accordance with some embodiments. In this data accumulation, the Doppler filtering at +40 Hz was insufficient to remove some of the incoming multipath. TOA-MF filtering helps to some extent. Several strong paths can be seen, but a quite weak early path is also apparent. By accumulating for longer than 50 ms, the Doppler filtering improves, but the TOA-MF filtering also improves as the SNR increases, and the SINR can then be increased with a tighter TOA-MF filter. With these improvements, the weak early path may become more visible. However, long-term accumulations in a cluttered area may not always work, because the multipath profile may change relatively quickly. For example, at a velocity of 55 km/h, the vehicle moves by 15 meters in just 1 second, which can result in significant change in the multipath environment, e.g., some multipath could disappear, others could appear, and some could exhibit a changing Doppler (which requires more complexity to track them), among other possibilities.

### Non-Coherent Approximate Maximum Likelihood (ML) Solution

The MUSIC (MUltiple SIgnal Classification) algorithm uses an estimated signal (i.e., multipath signals that include a signal of interest) and noise covariance matrix (e.g., created at 1306-1308, described below) in order to locate the multipath signals and isolate the signal of interest. It finds the strongest eigen vectors in this matrix and operates under the assumption that they contain the signal (signal subspace). The rest is assumed to be noise (i.e., the noise subspace). Therefore, the algorithm projects each possible signal path delay onto the signal subspace and selects the path delays that appear to fit inside the signal subspace. In other words, it projects each possible signal path delay onto the noise subspace, and selects the paths that are orthogonal to the noise space.

In some embodiments, a non-coherent approximate Maximum Likelihood (ML) solution can be formulated somewhat similarly to the MUSIC formulation, but is generally superior to the MUSIC formulation. The ML solution is suitable when the carrier phase between segments (aᵢ below) cannot be tracked due to unpredictable changes in the channel's carrier phases, or due to different sensors used (e.g., different antennas), i.e., for a non-coherent case. The ML solution formulation of the non-coherent case is not an exact ML formulation but is quite close and shows that the covariance matrix needs to be maintained.

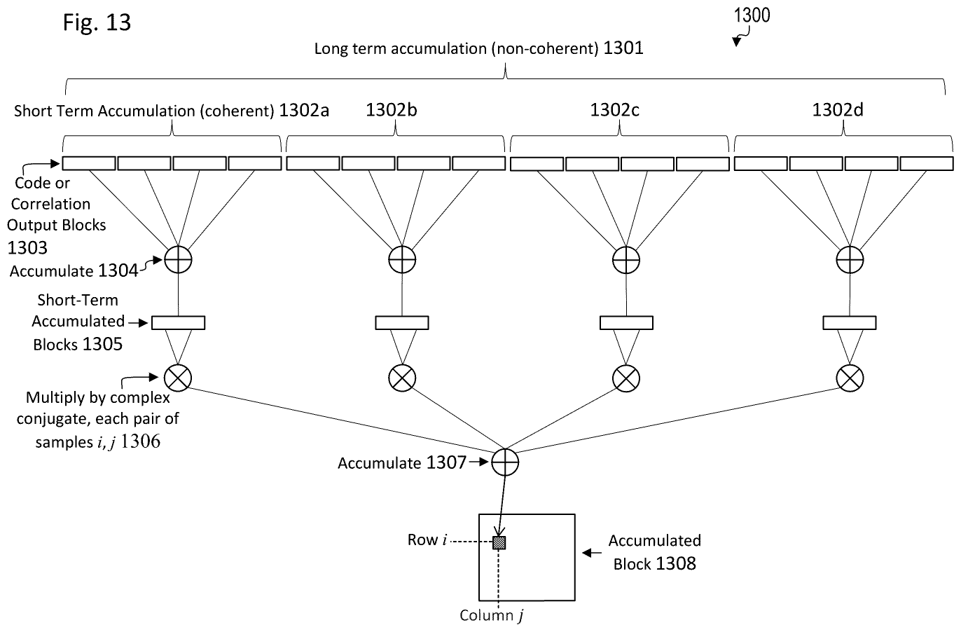

FIG. 13 is a simplified schematic diagram showing an example overview of a process 1300 for a non-coherent approximate ML solution that can be used for a TOA calculation, in accordance with some embodiments. In general, the long-term accumulation 1301 is divided into multiple coherent short-term accumulations 1302a-d (or segments), i.e., the long-term accumulation 1301 in the time domain is accomplished by implementing a series of coherent short-term accumulation segments 1302a-d of individual code blocks or correlation output blocks 1303 (e.g., including generating a correlated received signal by performing TOA-MF filtering and correlating of the received multipath signal with a local replica of the code). The samples in the segments of the code blocks or correlation output blocks 1303 (e.g., 1 ms CDMA or GNSS codes) are accumulated (at 1304) to generate multiple respective coherent short-term accumulated blocks 1305 (i.e., each is a block of several samples).

The cross-correlation with the complex conjugate is determined (at 1306) for the samples to generate cross-correlated samples. Each pair of the samples (e.g., row/column—i, j) are thus multiplied by the complex conjugate. The segment results at 1306 (i.e., the cross-correlated samples) are then further accumulated (at 1307) to generate a long-term accumulated block 1308 (i.e., for each pair of the samples, e.g., at row/column i, j, for the long-term accumulation 1301) of a two-dimensional matrix or table. This is the covariance matrix of the signal and the noise, which can be used to estimate the time of arrival of the signal of interest, which further can be used to determine the position of the computing device. Each value at row and column i, j is thus the long term cross correlation of one sample with another sample. This can be done either at the block stage or accumulated block per Doppler hypothesis. This is further described below.

In accordance with the above process 1300, the signal model received in the signal data is assumed to be:

$$y = Xa + ϵ . \qquad ( Equation 3 )$$

where X is a matrix of the delayed multipath (e.g., with horizontal concatenation of reference transmitted signals, where each column xⱼ corresponds to some delay (multipath)), a is the vector of complex amplitude per column in X, ∈ is the noise vector assumed Gaussian, and y is the received signal vector.

The ML estimate (e.g., at 1302a-d or 1303) for the unknown a given a set of time hypotheses on the delays in X is vector:

$$\hat{a} = {( {\hat{X}}^{H} \hat{X} )}^{- 1} {\hat{X}}^{H} y . \qquad ( Equation 4 )$$

The winning set of time hypotheses in \hat{X} can be found by:

$${max}_{\hat{X}} {y}^{H} {\hat{X} ( {\hat{X}}^{H} \hat{X} )}^{- 1} {\hat{X}}^{H} y . \qquad ( Equation 5 )$$

If the signal data is accumulated non-coherently over multiple segments i (e.g., multiple time segments, multiple antennas, multiple spectrums, multiple sub-bands of a spectrum, or a mixture thereof) yᵢ=Xaᵢ+∈ᵢ is received with independently changing aᵢ but fixed time hypotheses in \hat{X} (e.g., assuming time delays in X don't change noticeably or can be tracked) then the ML can be formulated as:

$${max}_{\hat{X}} {\sum }_{i} {y}_{i}^{H} {\hat{X} ( {\hat{X}}^{H} \hat{X} )}^{- 1} {\hat{X}}^{H} {y}_{i} . \qquad ( Equation 6 )$$

Implicit assumptions in this formulation are that the aᵢ are entirely independent (i.e., amplitudes and phases) between segments i (which is not always necessarily true) and often the amplitude of the terms remains roughly constant. However, it is assumed that the aᵢ are truly independent in the following example. Additionally, \hat{X}(\hat{X}^{H}\hat{X})⁻¹\hat{X}^{H} is a projection matrix and can be optionally replaced by the QR decomposition QR_{X}=\hat{X} that leads to:

$${max}_{\hat{X}} {\sum }_{i} {y}_{i}^{H} {QQ}^{H} {y}_{i} . \qquad ( Equation 7 )$$

Therefore, what matters is an orthonormal basis of X represented by Q. Thus, this can be rearranged as:

$${max}_{\hat{X}} trace {Q}^{H} ( {\sum }_{i} {y}_{i} {y}_{i}^{H} ) Q . \qquad ( Equation 8 )$$

This can be rewritten as:

$${max}_{\hat{X}} trace {Q}^{H} {R}_{y} Q . \qquad ( Equation 9 )$$

Where R_{y}=Σᵢyᵢyᵢ^{H} is the covariance matrix (e.g., generated at 1306-1308) of the received signal yᵢ (or signal samples), which is typically computed in the MUSIC algorithm.

In some embodiments, the Eigen decomposition R_{y}=UDU^{H} may optionally be obtained, and hence:

$${max}_{\hat{X}} trace {Q}^{H} UD {U}^{H} Q . \qquad ( Equation 10 )$$

This may also be written as:

$${max}_{\hat{X}} {\sum }_{j} {\vert {q}_{j}^{H} U {D}^{1 / 2} \vert}^{2} . \qquad ( Equation 11 )$$

Wherein qⱼ is the jth column of Q. The object is then to find the set of time delayed vectors \hat{x}ⱼ in \hat{X} that generate the subspace Q and that maximize the above non-coherent correlation of the signal samples. This correlation is computed and indicates where the arrival of the signal of interest is. In this manner, therefore, Equations 8-11 generally search for the paths and the maximum to determine or isolate the signal of interest.

Although the MUSIC algorithm assigns to the subspace of Q the strongest eigen vectors in U, and attempts to find the set of \hat{x}ⱼ that lie in this subspace, this is not what the ML solution suggests. Instead, the ML solution suggests finding the set \hat{x}ⱼ, or subspace spanned by \hat{X}, that maximizes the non-coherent correlation (Equations 7, 8, 9, 10 or 11). This cost function includes both signal and noise subspaces. There is no need to make a distinction between the two subspaces. In fact, some multipath or partial multipath components can be found in the noise subspace.

In some embodiments, it is an option to ignore from the summation the vectors or subspace corresponding to negligible eigen values, which, for example, arise from a non-full rank covariance matrix due to summing j over fewer segments than there are dimensions in R_{y}. However, the dimensions containing weak noise should not be ignored. Thus, a distinction can be made between a) negligible dimensions or zero eigen values, b) noise only dimensions, and c) multipath dimensions of a useful signal, i.e., the signal of interest. The MUSIC algorithm assumes that the strongest eigen vectors of the eigen decomposition contain the multipath dimensions of a useful signal (option c), while the weaker eigen vectors contain the noise-only dimensions (option b). However, in some embodiments, it is implied that parts of the multipath dimensions of a useful signal may be present in the weaker eigen vectors (option b). Additionally, unlike in the MUSIC algorithm, there is no need to determine which may be considered strong eigen vectors and which may be considered weak eigen vectors. Thus, in some embodiments, the present invention uses all the eigen vectors (optionally excluding the zero eigen vectors).

Furthermore, the set \hat{x}ⱼ can be jointly optimized according to this formulation, rather than separately optimized as is typically done in MUSIC. Thus, a solution can be specified starting with an approach similar to MUSIC, wherein each candidate path that maximizes the non-coherent correlation is separately determined. Then a gradient descent method is used where each (or several) \hat{x}ⱼ is fine-tuned by being shifted in the time domain, successively and iteratively until the maximum is found. If two paths collide as they are shifted, they may be merged. The gradient may be obtained numerically, wherein column j of \hat{X} is time shifted by dt, the QR decomposition is recomputed and the non-coherent correlation is reevaluated. The change in the non-coherent correlation over dt is the component j of the gradient. After computing all the components, the process may move along the gradient direction by a step, and repeat. If two paths in \hat{X} start to merge, they can be replaced by a unique path.

In some embodiments, in a coordinate descent method where iteration is performed by optimizing one coordinate at a time, when searching over one of the \hat{x}ⱼ, the \hat{x}ⱼ can be reordered and placed at the end for the QR decomposition. In this case, moving \hat{x}ⱼ only impacts the last vector qⱼ in Q, which in turn impacts only one term in the summation Σⱼ|qⱼ^{H}UD^{1/2}|². This enables more efficient computation, because \hat{x}ⱼ is shifted in time in the coordinate descent method, and updating the last column of Q is quite efficient. Once a maximum is found for a given \hat{x}ⱼ, the process moves to another \hat{x}_{j′}, which may again be placed at the end for the QR decomposition. If \hat{x}_{j′} was immediately preceding \hat{x}ⱼ in the previous QR decomposition, then the updated QR decomposition exhibits changes only in the last two columns. The process performs similarly as it moves to a 3^{rd} and beyond vector in \hat{X}. In other words, \hat{X} should be presorted in the reverse order to what vectors will be displaced in the gradient descent (at each stage).

In some embodiments, if noise power is estimated via various methods, then it is possible to tell what the multipath power should be, which is a part of the trace of R_{y}. The process keeps adding multipath (by increasing the hypothesis M) until it finds that their power plus the noise component power is the trace of R_{y}.

### Separability of Multipath Via the Covariance Matrix

By excluding the noise part of the signal, the accumulation to obtain the signal covariance matrix consists of accumulating ΣXaᵢaᵢ^{H}X^{H}=XRₐX^{H}, where the covariance matrix Rₐ=Σaᵢaᵢ^{H} is non-diagonal. In this case, cross-correlations exist between multipath and this weakens the ability to separate them based on Doppler alone. For example, when two paths have relatively similar Doppler, they generate mainly a 1D line (i.e., a linear combination of the two paths), rather than a 2D plane, where the line is a sum of the two path vectors. It is therefore difficult to distinguish these two paths once the noise is included. In fact, using a Cholesky decomposition Rₐ=LₐLₐ^{H}, and letting X′=XLₐ, then the covariance matrix is X′X′^{H} instead of XX^{H}. When the cross-correlations Rₐ are quite strong relative to noise, the vectors in X′ don't represent sufficiently well the original vectors in X (e.g., the generated plane represents mainly a line). Additionally, the signal space determined by the MUSIC algorithm is that of X′, rather than that of X. And some vectors in X′, which are linear combinations of two vectors in X may not match any vector in X (instead, they match the linear combination of two vectors). Hence, the MUSIC algorithm fails to find such multipath. This is also the case when two paths are quite near in code phase, wherein they do not represent an orthogonal 2D subspace. Thus, their cross-correlation leads to confusion once the noise part is added.

In principle, when two paths “merge” to some extent inside the covariance matrix due to insufficient orthogonality, the correct estimation problem involves searching for the two paths simultaneously as one vector inside the maximum non-coherent correlation formula, which is typically a costly solution.

### Covariance Matrix Combined with TOA-MF

In order to improve code phase estimation using a non-costly method, the technique of TOA-MF or similar frequency domain windowing (e.g., a Dolph-Chebyshev windowing as described in U.S. Pat. Nos. 10,042,037 and 10,880,678) is additionally applied. The TOA-MF is focused on determining the earliest time of arrival, i.e., the signal of interest. A window like Dolph-Chebyshev can help improve the separation between any multipath (not just the earliest arrival). Such windowing pre-distorts the vectors in X in order to render them relatively orthogonal in the code phase space. This generally has at least two advantages, a) it improves the properties of the covariance matrix XX^{H} against noise, e.g., by generating a signal subspace with stronger orthogonal dimensions, and b) more importantly, in the case of earliest time of arrival estimation, it enables focusing on the start of the energy region (i.e., the operating region), independently of the late arrivals. Advantage (b) is especially useful when there are many late arrivals that are hard to separate (e.g., a dense multipath).

When TOA-MF (or similar windowing) is applied to find the earliest arrival (as in Advantage (b) in the previous paragraph), the start of signal energy is first identified, which is a relatively simple problem after applying such filters. For instance, the diagonal of R_{y}, which is essentially the non-coherent accumulation of the segments after pre-distortion of yᵢ by the TOA-MF filter, generally shows where the signal energy starts. Since most of the useful information for the first path (as described in U.S. Pat. No. 10,042,037) is located in an operating region toward the start of the energy of the signal, therefore the process may extract a few correlators from the covariance matrix R_{y} and corresponding cross-correlations, i.e., a small square matrix is extracted out of R_{y}, and this square matrix may be used for maximizing a non-coherent correlation. This is an improvement over the solution given in U.S. Pat. Nos. 10,042,037 and 10,880,678 by considering the covariance matrix of the correlators instead of the squared correlators alone. In this case, the process 1300 focuses on locating the earliest path(s) without detecting the late paths.

As soon as the operating region is located, there is no need to compute and maintain a large covariance matrix R_{y}. Instead, it is sufficient to compute a small covariance matrix R_{y}^{small} consisting of only the samples in the operating region. For example, the small covariance matrix may be as small as 2×2 if the operating region consists of only two nearby samples.

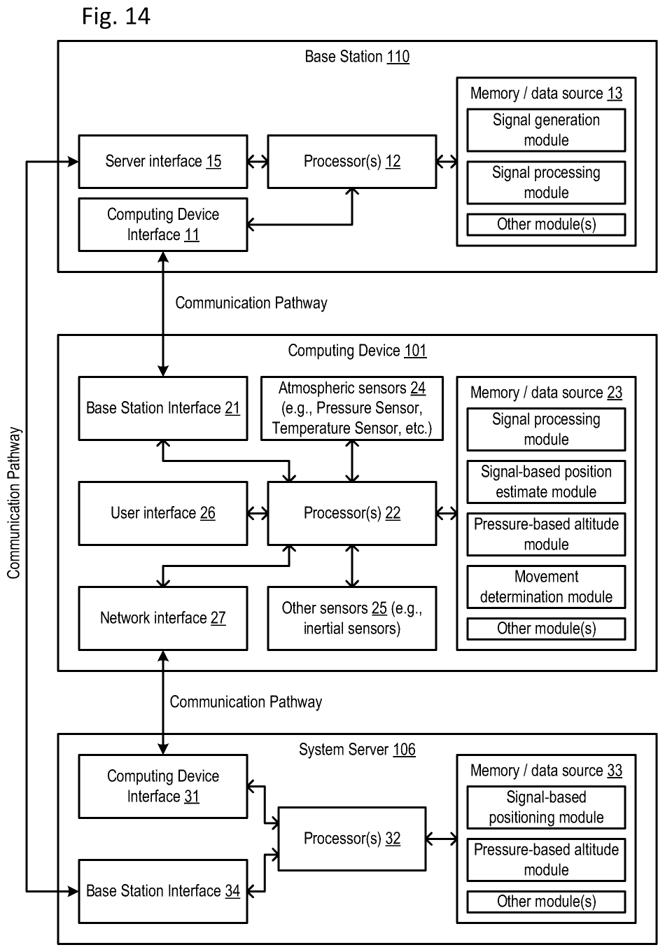

FIG. 14 illustrates components of an example of the base stations 110, an example of the computing devices 101, and an example of the system server 106 of the operational environment 100 shown in FIG. 1, in accordance with some embodiments. Examples of communication pathways are shown by arrows between components. The components shown in FIG. 14 are operable to perform all or a portion of the processes described with reference to FIGS. 1-13.

By way of example in FIG. 14, each of the base stations 110 may include: a computing device interface 11 for exchanging information with the computing devices 101 (e.g., antenna(s) and RF front-end components known in the art or otherwise disclosed herein); one or more processor(s) 12; memory/data source 13 for providing storage and retrieval of information and/or program instructions; a server interface 15 for exchanging information with the system server 106 (e.g., an antenna, a network interface, or other); and any other components known to one of ordinary skill in the art. The memory/data source 13 may include a non-transitory memory storing software modules (non-limiting examples shown) with executable instructions, and the processor(s) 12 may perform different actions by executing the instructions from the modules, including (i) performance of a part or all of the methods or processes as described herein or otherwise understood by one of skill in the art as being performable at the base station 110; (ii) generation of positioning signals for transmission using a selected time, frequency, code, and/or phase; (iii) processing of signals received from the computing device or another source; and/or (iv) other processing as required by operations described in this disclosure. Signals generated and transmitted by a base station may carry different information that, once determined by a computing device or a server, may identify the base station's position and/or other positioning information known in the art.

By way of example in FIG. 14, the computing device 101 may include: a base station interface 21 for exchanging information with a base station (e.g., an antenna and RF front-end components known in the art or otherwise disclosed herein); one or more processor(s) 22; memory/data source 23 for providing storage and retrieval of information and/or program instructions; atmospheric sensor(s) 24 (such as barometers and temperature sensors) for measuring environmental conditions (e.g., pressure, temperature, other) at the computing device; other sensor(s) 25 for measuring other conditions (e.g., inertial sensors for measuring movement and orientation); a user interface 26 (e.g., display, keyboard, microphone, speaker, other) for permitting a user to provide inputs and receive outputs; a network interface 27 for exchanging information with the system server 106 or other devices external to the computing device (e.g., an antenna, a network interface, or other); and any other components known to one of ordinary skill in the art. A GNSS interface and processing unit (not shown) are contemplated, which may be integrated with other components (e.g., the interface 21 and the processors 22) or a standalone antenna, RF front end, and processors dedicated to receiving and processing GNSS signaling. The memory/data source 23 may include a non-transitory memory (e.g., a data storage module) storing software modules (non-limiting examples shown) with executable instructions, and the processor(s) 22 may perform different actions by executing the instructions from the modules, including (i) performance of a part or all of the methods as described herein or otherwise understood by one of ordinary skill in the art as being performable at the computing device; (ii) estimation of an altitude of the computing device based on measurements of pressure from the computing device and terrain data, temperature measurement(s) from reference pressure station(s) or another source, and any other information needed for the computation; (iii) processing of received signals to determine position information (e.g., times of arrival or travel time of the signals, PRN code, pseudoranges between the computing device and base stations, reference pressure station atmospheric conditions, and/or locations or other base station information); (iv) use of position information to compute an estimated position/location of the computing device; (v) determination of movement based on measurements from inertial sensors of the computing device; (vi) GNSS signal processing; (vii) TOA-MF filtering; (viii) short-term and long-term data accumulation; (ix) carrier phase correction and accumulation windowing; (x) Doppler hypothesis determination; (xi) FFTs; (xii) cross-correlation; and/or (xiii) other processing as required by operations described in this disclosure.

By way of example in FIG. 14, the system server 106 may include: a computing device interface 31 for exchanging information with a computing device (e.g., an antenna, a network interface, or other); one or more processor(s) 32; memory/data source 33 for providing storage and retrieval of information and/or program instructions; a base station interface 34 for exchanging information with a base station (e.g., an antenna, a network interface, or other); and any other components known to one of ordinary skill in the art. The memory/data source 33 may include a non-transitory memory storing software modules (non-limiting examples shown) with executable instructions, and the processor(s) 32 may perform different actions by executing instructions from the modules, including (i) performance of a part or all of the methods as described herein or otherwise understood by one of ordinary skill in the art as being performable at the server; (ii) estimation of an altitude of the computing device; (iii) computation of an estimated position of the computing device; (iv) TOA-MF filtering; (v) short-term and long-term data accumulation; (vi) carrier phase correction and accumulation windowing; (vii) Doppler hypothesis determination; (viii) FFTs; (ix) cross-correlation; and/or (x) other processing as required by operations described in this disclosure. Steps performed by servers as described herein may also be performed on other machines that are remote from a computing device, including computers of enterprises or any other suitable machine.

Reference has been made in detail to embodiments of the disclosed invention, one or more examples of which have been illustrated in the accompanying figures. Each example has been provided by way of an explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is, a claim may be amended to include a feature defined in any other claim. Furthermore, a phrase referring to “at least one of” a list of items refers to any combination of those items, including single members. As an example, “at least one of: a, b, or c” is intended to cover: a, b, c, a-b, a-c, b-c, and a-b-c.

What is claimed is:

1. A method comprising:
receiving, by a computing system, a multipath signal comprising a code, the code being a Pseudo-Random-Noise (PRN) code of a system in which the code is used to determine a time of arrival of a signal of interest within the multipath signal;
generating a correlated received signal by performing, by the computing system, filtering and correlating of the received multipath signal with a local replica of the code;
generating, by the computing system, a plurality of short-term accumulation segments based on the correlated received signal;
applying, by the computing system, a plurality of Doppler hypotheses to each of the short-term accumulation segments to generate sets of phase-corrected short-term accumulated blocks; and
accumulating, by the computing system, the phase-corrected short-term accumulated blocks to generate long-term accumulated blocks for each Doppler hypothesis.

2. The method of claim 1, wherein:
the filtering performs a code based Time of Arrival Matched Filter (TOA-MF) or near-causal filtering.

3. The method of claim 1, further comprising:
performing time of arrival estimation for the signal of interest using the long-term accumulated blocks.

4. The method of claim 3, further comprising:
determining a position of the computing system using the time of arrival estimation.

5. The method of claim 1, wherein:
the applying of the plurality of Doppler hypotheses isolates the signal of interest within the multipath signal.

6. The method of claim 1, further comprising:
determining the signal of interest as an earliest signal from among the multipath signal or a strongest signal among multiple earliest signals from among the multipath signal.

7. The method of claim 1, wherein:
the applying of the plurality of Doppler hypotheses performs carrier phase correction and accumulation windowing for each of the short-term accumulation segments.

8. The method of claim 1, wherein:
each Doppler hypothesis of the plurality of Doppler hypotheses is applied separately as a carrier phase ramp or a discrete Fourier transform.

9. The method of claim 1, wherein:
the plurality of Doppler hypotheses are applied in parallel using respective Fast Fourier Transforms.

10. The method of claim 1, wherein:
the plurality of Doppler hypotheses are applied using respective oversampled Fast Fourier Transforms with a time domain block length extended with zero padding.

11. The method of claim 1, further comprising:
applying the filtering onto blocks of the PRN code.

12. A method comprising:
receiving, by a computing system, signal data that includes a plurality of signal samples that includes a signal of interest and that are accumulated non-coherently;
generating a correlated received signal by performing, by the computing system, filtering and correlating of the received multipath signal with a local replica of the code;
generating, by the computing system, a plurality of short-term accumulation segments using the signal samples;
accumulating, by the computing system, blocks of signal samples in each of the short-term accumulation segments to generate a plurality of short-term accumulated blocks;
for each short-term accumulation segment, determining, by the computing system, a cross-correlation for each of the signal samples therein to generate cross-correlated samples; and
accumulating, by the computing system, the cross-correlated samples to generate a long-term accumulated block.

13. The method of claim 12, wherein:
the cross-correlated samples and the long-term accumulated block result in a covariance matrix of the received signal samples.

14. The method of claim 12, wherein:
the short-term accumulation segments are coherent.

15. The method of claim 12, further comprising:
performing time of arrival estimation for the signal of interest using the long-term accumulated blocks.

16. The method of claim 15, further comprising:
determining a position of the computing system using the time of arrival estimation.

17. The method of claim 12, further comprising:
estimating a non-coherent Maximum Likelihood (ML) solution using a matrix of delayed multipath with fixed time hypotheses for the signal samples and an independently changing vector of complex amplitude per column of the matrix of delayed multipath.

18. The method of claim 17, further comprising:
maximizing a non-coherent correlation for the signal samples using time delayed vectors in the fixed time hypotheses to determine the signal of interest.
